(19) United States
(12) Patent Application Publication
(10) Pub. No.: US 2007/0151399 A1
(43) Pub. Date: Jul. 5, 2007

(54) Integrated parking brake lever and console assembly

(75) Inventor: Jason Gamache, Romeo, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/315,575

(22) Filed: Dec. 22, 2005

(51) Int. Cl. G05G 1/04

(52) U.S. Cl. 74/523

(57) ABSTRACT

An integrated parking brake lever and center console assembly for a vehicle includes a parking brake lever and a center console. The parking brake lever is structured and configured to be pivotally mounted to a vehicle frame and is movable between a brake released position and a brake actuated position. The center console defines a storage compartment and is attached to the parking brake lever. The console is moveable with the parking brake lever as the parking brake lever is moved between the brake released position and the brake actuated position.

### BACKGROUND OF THE INVENTION

The present invention relates to hand operated parking brake levers for motor vehicles. More particularly, the present invention relates to a hand operated parking brake lever integrated with a vehicle center console.

Hand operated parking brake levers, such as a pull-to-release lever may be provided between the driver and front seat passenger to be accessible to the vehicle driver. Vehicle drivers often desire a console with a storage compartment to also be provided between the two front vehicle seats. Because of the space required for the brake lever however, vehicles may be provided without a console, with an undesirably small console, or an awkwardly located console.

### BRIEF DESCRIPTION OF THE DRAWINGS

FIG. 1 is a perspective view of a portion of a vehicle interior showing a driver seat and a front passenger seat with a center console assembly according to the present invention disposed between the seats.

FIG. 2 is a side elevational view of a first embodiment of the center console assembly illustrated in FIG. 1.

FIG. 3 is a side elevational view of a second embodiment of the center console assembly illustrated in FIG. 1.

FIG. 4 is a side elevational view of a third embodiment of the center console assembly according to the present invention.

### DETAILED DESCRIPTION OF THE INVENTION

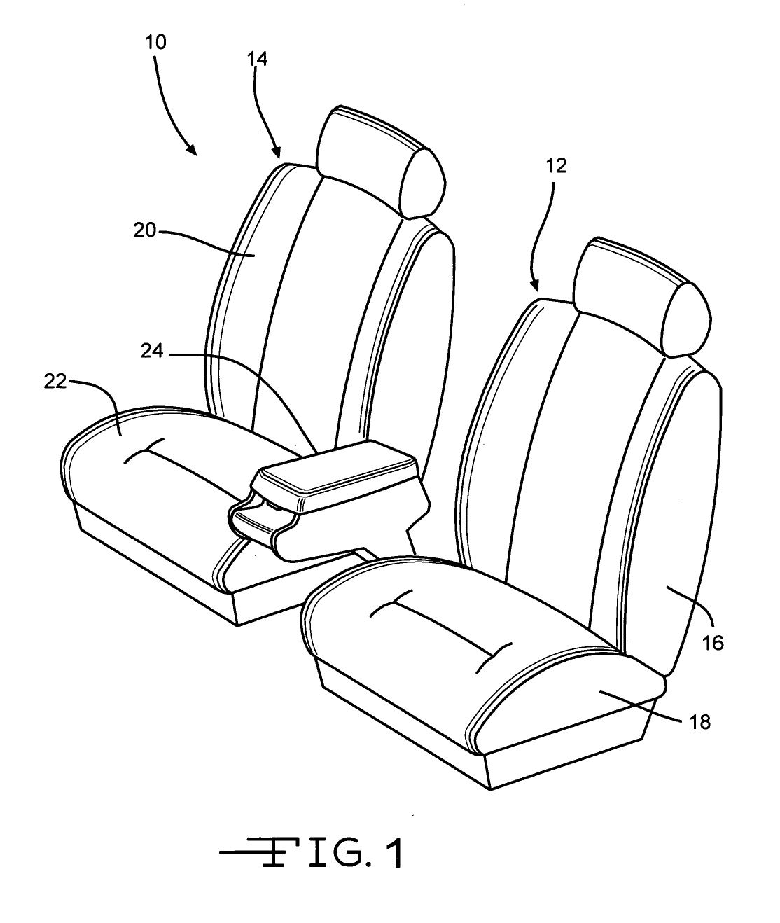

Referring now to the drawings, there is illustrated in FIG. 1 a front seat assembly for an automotive passenger vehicle, shown generally at 10. The illustrated front seat assembly 10 includes a driver's seat 12 and a front passenger seat 14. The driver's seat 12 includes an upright seat back portion 16 and a horizontal seat portion 18. Likewise, the passenger seat 14 includes an upright seat back portion 20 and a horizontal seat portion 22.

In the exemplary embodiment illustrated in FIG. 1, an integrated parking brake lever and center console assembly 24 is disposed between the seats 12 and 14. In the illustrated embodiment, the console assembly 24 is pivotally mounted to the vehicle frame as described in detail below.

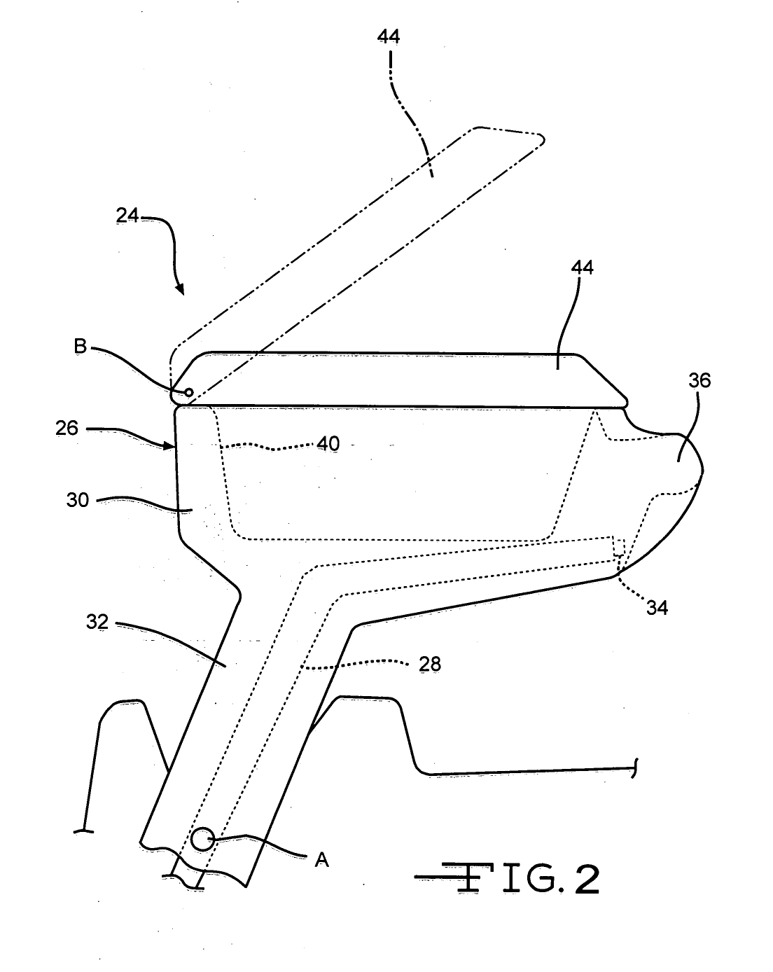

A first embodiment of the console assembly 24 is illustrated in FIG. 2. As shown in FIG. 2, the console assembly 24 includes a center console 26 and a parking brake lever 28. The center console 26 may include a console body 30 and an arm 32. As shown in FIG. 2, the center console assembly 24 is attached to the parking brake lever 28. The center console assembly 24 may be attached to the lever 28 by any desired means, such as with adhesive, or with fasteners. Alternately, the lever 28 may be integrally molded, formed, or incorporated within the center console assembly 24. In the exemplary embodiment illustrated, the lever 28 and the arm 32 are pivotally mounted to the vehicle frame about a pivot axis A at the base of the arm 32, and connected to a parking brake actuating mechanism for a parking brake (not shown).

The console body 30 and the arm 32 can be formed from any desired substantially rigid material, such as plastic. Materials such as polypropylene, nylon, acrylonitrile butadiene styrene (ABS), and polycarbonate acrylonitrile butadiene styrene (PCABS) may be used for the console body 30 and the arm 32 because of their strength and rigidity.

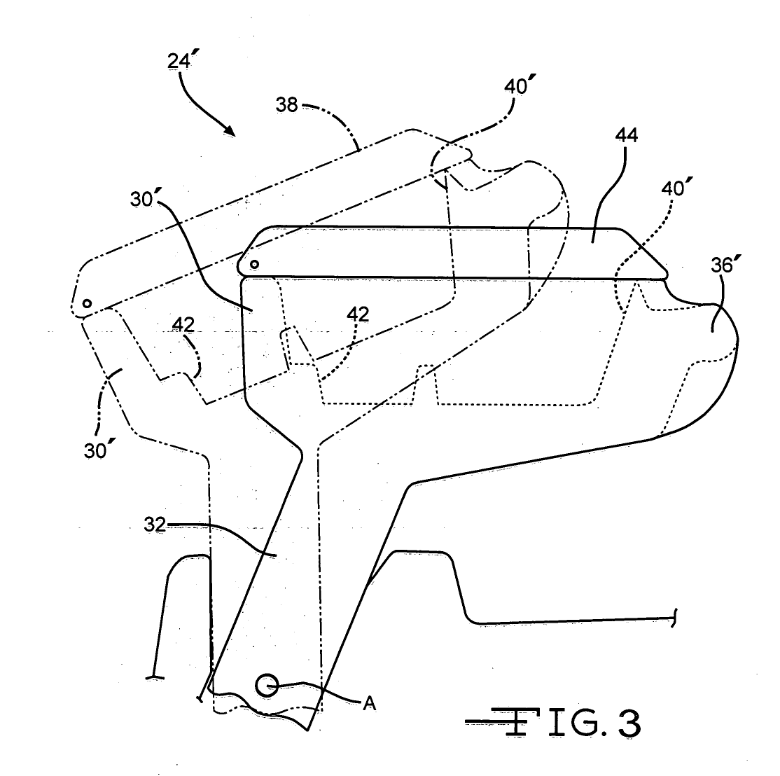

The brake lever 28 may be of the non-retractable type or the retractable type. As is known to one skilled in the art, the lever portion of a non-retractable type parking brake remains in an engaged or brake actuated position (such as shown by the phantom line 38 in FIG. 3) after being pulled from a brake stored or released position (as shown in FIGS. 2 and 3). The lever portion of a retractable type parking brake is returnable to the stored or released position with the parking brake remaining applied.

In the exemplary embodiment illustrated in FIG. 2, the center console assembly 24 (including the brake lever 28) is shown in the brake released position. The brake lever 28 may be pulled from the brake released position to a brake actuated position (such as shown by the phantom line 38 in FIG. 3), and includes a brake actuator, such as a spring biased button 34. In the embodiment illustrated, the button 34 may be attached to a disengagement member (not shown) that pushes or pulls a pawl from engagement with gear teeth of a parking brake actuating mechanism (not shown), thereby releasing or moving the parking brake from the brake released position to the brake actuated position. The console body 30 may include a hand engagable portion or handle 36 for moving the console assembly 24, including the brake lever 28, from the brake released position as shown in FIGS. 2 and 3, to the brake actuated position, as shown by the phantom line 38 in FIG. 3.

As shown in FIGS. 2 and 3, the center console assembly 24 may include a storage compartment 40, however such a storage compartment is not required. The storage compartment 40 may be structured and configured to store any desired objects. If desired, a portion of the storage compartment 40 may also be structured and configured as a cup holder, such as shown at 42 in FIG. 3.

The center console assembly 24 may also include a lid 44. As best shown in FIG. 2, the lid 44 is pivotally attached to the center console assembly 24 about a pivot axis B. It will be understood however, that the lid 44 may be attached to the center console assembly 24 by any other desired means. The lid 44 may be moved from a closed position as shown in FIGS. 2 and 3 to an open position as shown in FIG. 2. When the lid 44 is in the closed position, the lid 44 may serve as an armrest for the vehicle driver and/or the front seat passenger.

Referring now to FIG. 3, and using like reference numbers to indicate corresponding parts, there is illustrated generally at 24′, a side elevational view of a second alternate embodiment of the center console assembly 24 discussed above. The integrated parking brake lever and center console assembly 24′ is substantially identical to the center console assembly 24, except that the center console assembly 24′ does not include the brake lever 28. In the exemplary embodiment illustrated in FIG. 3, the console assembly 24′ includes the console body 30′ having a storage compartment 40′. The parking brake lever is integrated with the console body 30′. The console body 30′ thus defines a parking brake lever, such that the brake lever 28 is not required. As described above regarding the console assembly 24, the console body 30′ and arm 32 of the console assembly 24′ are structured and configured to be pivotally mounted to a vehicle frame about the axis A, and movable between a brake released position and a brake actuated position.

The integrated parking brake lever and console assembly 24′ may be of the non-retractable type or the retractable type as described in detail above. The console body 30′ illustrated in FIG. 3 further includes a hand engagable portion or handle 36′ for moving the integrated parking brake lever and console assembly 24′ from the brake released position as shown in FIGS. 2 and 3, to the brake actuated position, as shown by the phantom line 38 in FIG. 3. The structure and operation of the integrated parking brake lever and console assembly 24′ is otherwise identical to that of the console assembly 24.

When the parking brake is to be set, i.e., when the console assembly 24, 24′ is moved to the brake actuated position as shown at 38 in FIG. 3, the hand engagable portion 36, 36′ is pulled upwardly by the vehicle operator. The console assembly 24, 24′ then pivots about the axis A in a counterclockwise direction (as shown by the arrow 70), engaging the parking brake actuating mechanism, and thereby actuating the parking brake.

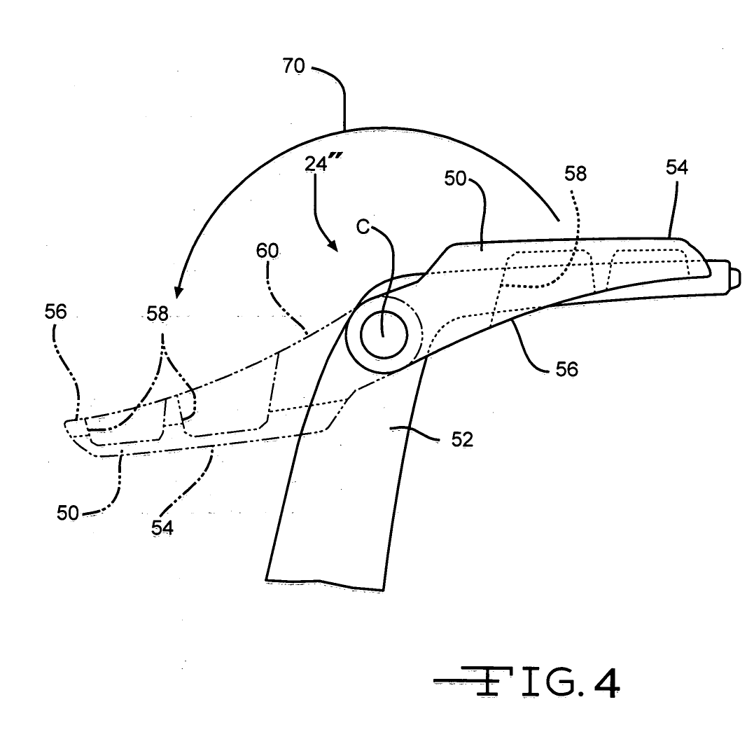

Referring now to FIG. 4, and using like reference numbers to indicate corresponding parts, there is illustrated generally at 24″, a side elevational view of a third alternate embodiment of the center console assembly 24 discussed above. The integrated parking brake lever and center console assembly 24″ includes a console body 50 pivotally mounted to a parking brake lever 52 about a pivot axis C. In the exemplary embodiment illustrated, the brake lever 52 is substantially identical to the brake lever 28 shown in FIG. 2.

The console body 50 may include a storage compartment, however such a storage compartment is not required. In the illustrated embodiment, the console body 50 includes a first surface 54 and a second surface 56, opposite the first surface 54. As shown, the second surface 56 defines a storage compartment 58. In the exemplary embodiment illustrated, the storage compartment is structured and configured as a plurality of cup holders 58, however, the storage compartment 58 may be structured and configured to store any desired objects. If desired, the console body 50 may include a lid (not shown) mounted thereto. The lid may be mounted to the console body 50 by any desired means, such as pivotally mounted. It will be understood that such a lid may further define an armrest.

As shown in FIG. 4, the console body 50 is pivotally moveable between a first deployed position (to the right as viewed in FIG. 4) and a second deployed position (to the left as viewed in FIG. 4 and as shown by the phantom line 60). In the first deployed position, the first surface 54 may define an armrest. In the second deployed position 60, the second surface 56 defines the storage compartment or cup holders 58. As described in detail above, the brake lever 52 is structured and configured to be pivotally mounted to a vehicle frame, and movable between the brake released position and the brake actuated position. The brake lever 52 may be of any desired type, such as the non-retractable or retractable type, as disclosed in detail above. The operation of the integrated parking brake lever and console assembly 24″ is otherwise identical to that of the console assembly 24 and the integrated parking brake lever and center console assembly 24′.

The principle and mode of operation of this invention have been described in its various embodiments. However, it should be noted that this invention may be practiced otherwise than as specifically illustrated and described without departing from its scope.

What is claimed is:

1. An integrated parking brake lever and center console assembly for a vehicle, said assembly comprising:
a parking brake lever structured and configured to be pivotally mounted to a vehicle frame and movable between a brake released position and a brake actuated position; and
a center console defining a storage compartment and attached to said parking brake lever, wherein said console is moveable with said parking brake lever as said parking brake lever is moved between said brake released position and said brake actuated position.

2. The assembly according to claim 1, wherein said storage compartment defines a cup holder.

3. The assembly according to claim 1, wherein a surface of said console defines an armrest.

4. The assembly according to claim 1, wherein said console further includes a lid pivotally mounted thereto.

5. The assembly according to claim 4, wherein a surface of said lid defines an armrest.

6. The assembly according to claim 1, wherein said center console is pivotally mounted to said parking brake lever.

7. The assembly according to claim 6, wherein said center console includes a first surface and a second surface, said center console being pivotally moveable between a first deployed position wherein said first surface defines an armrest, and a second deployed position wherein said second surface defines said storage compartment.

8. The assembly according to claim 7, wherein said storage compartment defines a cup holder.

9. The assembly according to claim 1, wherein said parking brake lever is integrally formed with said center console.

10. An integrated parking brake lever and center console assembly for a vehicle, said assembly comprising a body defining a center console and having a storage compartment therein, said body further defining a parking brake lever,
wherein said body is structured and configured to be pivotally mounted to a vehicle frame and movable between a brake released position and a brake actuated position.

11. The assembly according to claim 10, wherein said storage compartment defines a cup holder.

12. The assembly according to claim 10, wherein a surface of said console defines an armrest.

13. The assembly according to claim 10, wherein said console further includes a lid pivotally mounted thereto.

14. The assembly according to claim 13, wherein a surface of said lid defines an armrest.
